(19) United States
(12) Patent Application Publication
(10) Pub. No.: US 2005/0188186 A1
(43) Pub. Date: Aug. 25, 2005

(54) Obtaining execution path information in an instruction sampling system

(76) Inventors: Mario I. Wolczko, San Carlos, CA (US); Adam R. Talcott, San Jose, CA (US)

Correspondence Address: HAMILTON & TERRILE, LLP, P.O. BOX 203518, AUSTIN, TX, 78720, US

(21) Appl. No.: 10/784,730

(22) Filed: Feb. 23, 2004

(51) Int. Cl. G06F 9/00

(52) U.S. Cl. 712/227

(57) ABSTRACT

A method of linking control transfer information with sampling information for instructions executing in a processor which includes storing information relating to execution events, selecting an instruction for sampling, storing information relating to the instruction for sampling, freezing the information relating to execution events when the information relating to the instruction for sampling is to be reported to provide frozen execution event information, reporting the information relating to the instruction for sampling, and enabling access to the frozen execution event information.

### BACKGROUND OF THE INVENTION

1. Field of the Invention

The present invention relates to processors, and more particularly to sampling mechanisms of processors.

2. Description of the Related Art

It is known how to provide a processor with an instruction sampling mechanism to allow software to gain insight into the behavior of the processor by capturing the histories of randomly selected instructions. An instruction sample is usually delivered to software some time after the sample was taken (possibly hundreds of cycles), and so software cannot examine the architected machine state extant at the time the sample information is gathered. Further, samples can be taken of instructions which do not retire (because, for example, the sampled instruction was on a mispredicted path). For these instructions, there is no software-visible machine state corresponding to the sampled instruction.

In understanding the significance of a sample, it is often useful to know the software path that led up to the sample. This allows software to put the sample in context; dynamic samples of the same static instruction may vary widely in their content, with the variations correlated to the path preceding the dynamic sample.

Known processors include a precise event-based sampling mechanism that can capture architectural state when a performance event occurs as well as a mechanism for recording the most recent control transfers. However, known processors do not link these two mechanisms.

### SUMMARY OF THE INVENTION

In accordance with the present invention, a processor is provided with an instruction sampling mechanism that is capable of providing detailed information about pseudo-randomly selected instruction executions as well as a history queue which records most recent control transfers. The sampling mechanism and the history queue are coupled, thus allowing the reconstruction of the path leading up to a sample. In one embodiment, the control transfers may be recorded regardless of whether the transfers are speculative or non-speculative.

More specifically, in one embodiment, the history queue is a taken control transfer instruction history queue which includes a freeze function when hardware detects that an instruction sample is about to be delivered to software. A handler, which receives an instruction sample can then also access the frozen contents of the history queue. Subsequent analysis of the sample and the captured history queue contents allows software to reconstruct the path leading up to the sample. Additionally, due to the early capture of control transfers by the history queue, a portion of the path immediately following the sample may also be included within the frozen contents of the history queue.

In one embodiment, the invention relates to a method of linking control transfer information with sampling information for instructions executing in a processor which includes storing information relating to execution events, selecting an instruction for sampling; storing information relating to the instruction for sampling, freezing the information relating to execution events when the information relating to the instruction for sampling is to be reported to provide frozen execution event information, reporting the information relating to the instruction for sampling, and enabling access to the frozen execution event information.

In another embodiment, the invention relates to an apparatus for linking control transfer information with sampling information for instructions executing in a processor which includes means for storing information relating to execution events, means for selecting an instruction for sampling, means for storing information relating to the instruction, means for freezing the information relating to execution events when the information relating to the instruction for sampling is to be reported to provide frozen execution event information, means for reporting the information relating to the instruction, and means for enabling access to the frozen execution event information.

In another embodiment, the invention relates to a processor which includes an instruction pipeline, a sampling mechanism coupled to the instruction pipeline and a history queue coupled to the pipeline. The sampling mechanism selects an instruction for sampling and storing information relating to the instruction for sampling. The history queue stores information relating to execution events and freezes the information relating to execution events when the information relating to the instruction for sampling is to be reported to provide frozen execution event information so as to enable linking control transfer information with sampling information for instructions executing in the processor.

In another embodiment, the invention relates to a method of monitoring control transfer information for instructions executing in a processor which includes storing information relating to execution events, freezing the information relating to execution events when the information relating to the instruction is to be reported to provide frozen execution event information, and enabling access to the frozen execution event information.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a processor having a sampling mechanism in accordance with the present invention.

FIG. 2 shows a block diagram of a history queue

### DETAILED DESCRIPTION

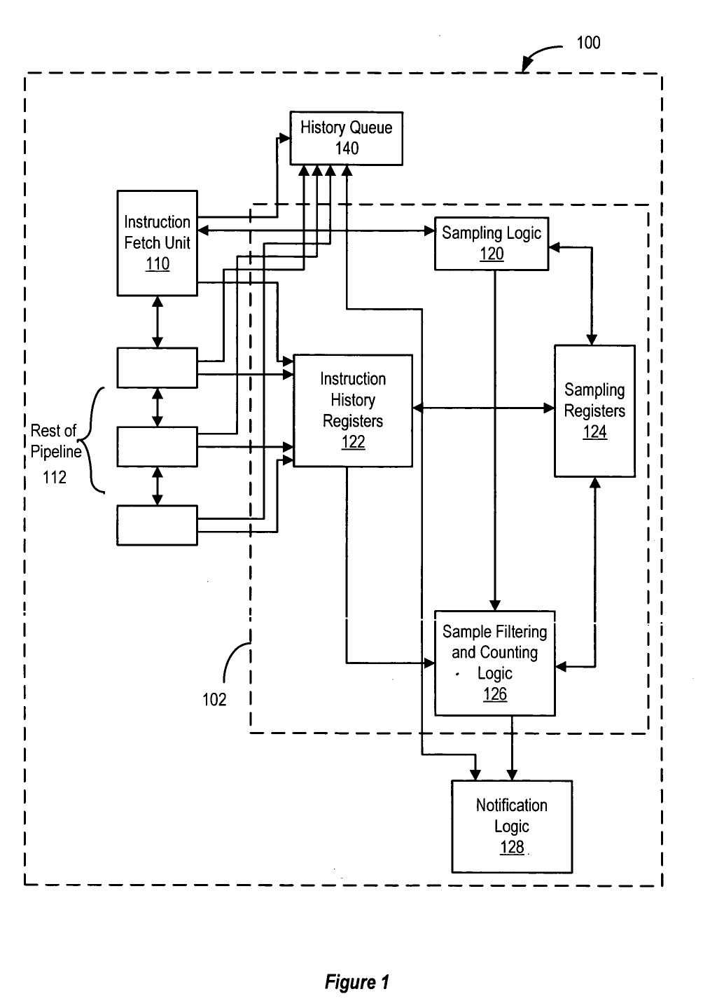

Referring to FIG. 1, processor 100 includes sampling mechanism 102. This sampling mechanism 102 is provided to collect detailed information about individual instruction executions. The sampling mechanism 102 is coupled to the instruction fetch unit 110 of the processor 100. The fetch unit 110 is also coupled to the remainder of the processor pipeline 112. Processor 100 includes additional processor elements as is well known in the art.

The sampling mechanism 102 includes sampling logic 120, instruction history registers 122, sampling registers 124, sample filtering and counting logic 126 and notification logic 128. The sampling logic 120 is coupled to the instruction fetch unit 110, the sampling registers 124 and the sample filtering and counting logic 126. The instruction history registers 122 receive inputs from the instruction fetch unit 110 as well as the remainder of the processor pipeline 112; the instruction history registers 122 are coupled to the sampling registers 124 and the sample filtering and counting logic 126. The sampling registers 124 are also coupled to the sample filtering and counting logic 126. The sample filtering and counting logic 126 are coupled to the notification logic 128.

The sampling mechanism 102 collects detailed information about individual instruction executions. If a sampled instruction meets certain criteria, the instruction becomes a reporting candidate. When the sampling mode is enabled, instructions are selected randomly by the processor 100 (via, e.g., a linear feedback shift register) as they are fetched. An instruction history is created for the selected instruction. The instruction history is made up of such things as events induced by the sample instruction and various associated latencies. When all events for the sample instruction have been generated (e.g., after the instruction retires or aborts), the vector of events gathered by the instruction history is compared with a user supplied vector, which indicates the events of interest.

The sampling mechanism is coupled to a history queue 140, thus allowing the reconstruction of the path leading up to a sample. The history queue 140 is a taken control transfer instruction history queue 140 which includes a freeze function when hardware detects that an instruction sample is about to be delivered to software. A handler, which receives an instruction sample, can then also access the frozen contents of the history queue 140. Subsequent analysis of the sample and the captured history queue contents allows software to reconstruct the path leading up to the sample.

Additionally, due to the early capture of control transfers by the history queue 140, a portion of the path immediately following the sample may also be included within the frozen contents of the history queue 140. For example, a branch instruction is added to the history queue 140 when the instruction starts executing but before the instruction branch is resolved. Accordingly, if the contents of the history queue 140 are frozen after the branch instruction starts executing, but before the branch instruction is resolved, then this information would be reflected within the contents of the history queue 140.

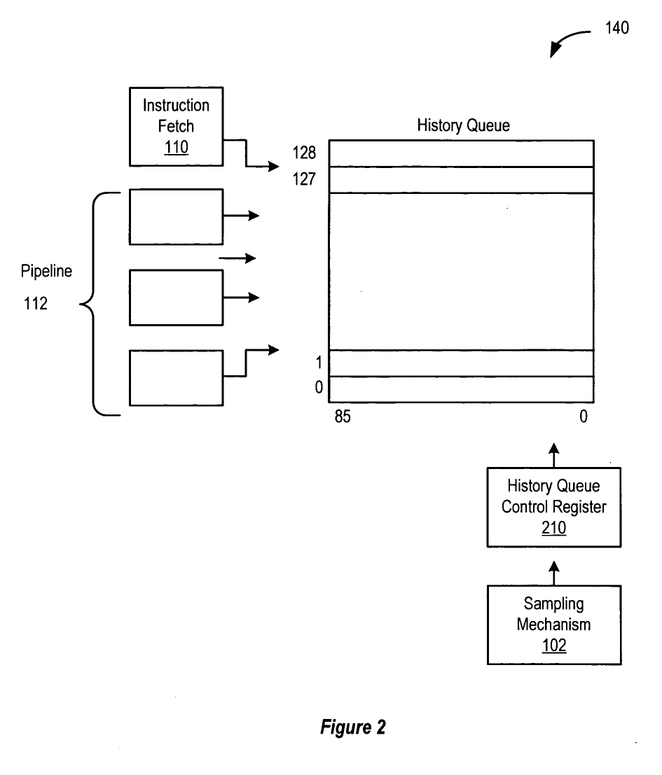

Referring to FIG. 2, in one embodiment, the history queue 140 is a circular queue of, for example, 128 entries. The history queue 140 enables the processor 100 to provide information which software can then use to reconstruct the flow of execution through the instruction space. The processor 100, and specifically the instruction fetch unit 110, writes to the queue when any of a plurality of control transfer events occur. The control transfer events include, for example, when a control transfer instruction is determined to be taken, when an instruction flush is performed and when an instruction takes a trap. The history queue 140 gathers information for one thread at a time. Using the information in the history queue 140, software can reconstruct a portion of the execution path through the instruction space. The history queue 140 is controlled via a history queue control register 210 which receives an input from, among others, the sampling mechanism 102.

Information in the history queue 140 is organized as a plurality of entries, where each entry includes a plurality of fields. More specifically, each entry within the history queue 140 includes a valid field, a program counter field, a privilege state field, a instruction flush field, a instruction flush replay field, a wrap bit field, a flush window identifier field, an instruction taken field, an instruction trap field, a wrap bit field, and a window identifier field.

The valid field indicates that a corresponding entry contains valid information; fields in the entry contain consistent and correct information only if the valid filed bit is set. The program counter field includes the program counter value of a resolved-taken control-transfer instruction (CTI) or trapping instruction; the program counter value is the address of the instruction itself, not the instruction address of the target of the control transfer instruction. The program counter value is only defined when either the instruction taken field or the instruction trap field are set. The privilege state field stores the value of the privilege state at the time the event in this entry originally occurred.

The instruction flush field value indicates that the entry contains information for an instruction flush. The instruction flush replay field is associated with an instruction flush event and indicates that an instruction flush was generated for a mispredicted branch and that the mispredicted branch now resolves not taken; the instruction flush replay field is only defined when the instruction flush value is set. The wrap bit field stores the wrap bit associated with the instruction flush; the wrap bit field value is only defined when the instruction flush value is set. The window identifier field provides the window identifier that is associated with the instruction flush; the window identifier field value only defined when the instruction flush value is set.

The instruction taken field indicates that the entry contains information for a control transfer instruction which was resolved taken. The instruction trap field indicates that the entry contains information for an instruction which caused a trap to be taken; traps are never taken speculatively. The wrap bit field stores the wrap bit associated with the resolved-taken control transfer instruction; the wrap bit field value is only defined when either the instruction taken field is set or the instruction trap field is set. The window identifier field stores the window identifier associated with the resolved-taken control transfer instruction; the window identifier value is only defined when either the instruction taken field is set or the instruction trap field is set. The history queue 140 gathers information until a software specified event occurs which freezes the contents of the history queue 140.

The history queue control register 210 includes a plurality of fields relating to controlling the history queue 140. The control fields include a sample freeze field and an enable field. The sample freeze field indicates to the history queue 140 to freeze the history queue contents when an instruction sample is reported to software. The enable field enables all writes to the history queue 140.

In operation, the enable bit in the control register controls all writes to the history queue 140. If the enable bit is cleared, then no new entries will be written to the history queue 140. When the enable bit is set, entries will be written to the history queue 140 as required. The enable bit is cleared after any type of reset. Therefore, software must explicitly set the enable bit to enable writes to the history queue 140.

Once the history contents are to be frozen (by, e.g., the sampling mechanism 102), the processor 100 automatically clears the enable bit to ensure that no subsequent writes occur to the history queue 140, thus ensuring that the contents of the history queue 140 are not modified before software can access the information. Should software wish to subsequently capture additional information, the software once again sets the enable bit.

To ensure that software always sees a coherent view of the history queue contents, the enable bit in the history queue control register is automatically cleared by hardware when software first reads the contents of the queue, thereby freezing the contents of the history queue 140. Freezing the contents of the history queue 140 after the first attempt by software to read the queue ensures that the contents are not altered by hardware while software is attempting to read the history queue 140.

Only reads of the history queue contents freeze the contents of the history queue 140. Restricting the history queue contents in this manner allows software to detect when the queue is frozen by polling the value of the enable bit in the taken history queue control register without interfering with on-going history queue writes.

Once the contents of the history queue 140 have been frozen, there are several methods by which the information stored within the history queue can be accessed. In one method, resetting the processor and reading out the contents of the history queue may be performed via accesses executed on the processor 100 itself. The contents of the history queue and associated registers are not initialized or modified in any way after all types of reset (including power-on reset). However, the enable bit in the taken history queue control register is always initialized to zero after all types of reset to ensure that no new entries are written to the history queue 140 until explicitly enabled by software. Finally, the contents of the history queue 140 may be read over the service bus using the existing mechanism to access corresponding on-chip locations.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, variations on the register configurations of the history queue and sampling mechanism are within the scope of the present invention.

Also for example, other types of events may freeze the contents of the history queue. For example, other conditions which can trigger freezing the contents of the history queue may include one or more of: an instruction breakpoint trap, an instruction watchpoint trap, or a instruction with the software trap number specified in a debug software trap number register; assertion of any bit in an error status register; overflow of any of the performance counters; and reading the contents of the history queue.

The history queue control register may be modified to include a plurality of fields relating to controlling the events which may freeze the contents of the history queue. For example, the history queue may include a trap freeze field which indicates to the history queue to freeze the history queue contents when a trap is taken, an error freeze field which indicates to the history queue to freeze the history queue contents when any bit in a global error status register is set, a performance counter freeze field which indicates to the history queue to freeze the history queue contents when a performance counter overflows.

The trap freeze event, error freeze event and performance counter freeze event are controlled by the trap freeze field, the error freeze field, and the performance counter freeze field, respectively. If one of these fields is set, then the contents of the history queue are frozen when the event associated with that control bit occurs. If more than one bit is set, then the contents of the history queue are frozen after the first enabled event occurs. If the bit is cleared, then that particular event has no effect on the operation of the history queue.

Software can also control which software trap number is used to freeze the contents of the history queue. The software trap number is specified within a Debug Software Trap Number Register. The information stored within this register indicates the software trap number which can be used with a Trap on Integer Condition Codes (Tcc) instruction which takes a trap to freeze the history queue.

Also for example, the history queue control register may also include a delay freeze field. If the delay freeze field is set, then the history queue continues to allow writes until a specified number of new entries are written in the queue after a control event occurs. The number of entries to be written before this delayed freeze is specified within the delay number field of the taken history queue control register. If the delay freeze field is set and more than one control event is enabled in the history queue control register, the delayed freeze of the history queue contents is triggered by the earliest detection of any enabled control event. The subsequent occurrence of any other enabled control event is ignored while a delayed freeze is pending.

Also for example, in a multithread mode of operation, it is possible that an event from one thread can trigger the history queue gathering information from another thread. For example, in one embodiment, the processor includes a single, global error status register which combines errors across both threads into one register. There is no way to filter out errors from a single thread, so an error in one thread might affect the information gathered in the history queue for the other thread. Only those traps from the thread specified in the thread identifier field of the taken history queue control register have any effect on the history queue.

Also for example, while a particular processor architecture and sampling mechanism architecture is set forth, it will be appreciated that variations within these architectures are within the scope of the present invention. Also, while various functional aspects of how the sampling mechanism interacts with the history queue, it will be appreciated that variations of the interaction are within the scope of the present invention.

Also for example, the above-discussed embodiments include modules that perform certain tasks. The modules discussed herein may include hardware modules or software modules. The hardware modules may be implemented within custom circuitry or via some form of programmable logic device. The software modules may include script, batch, or other executable files. The modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

1. A method of linking control transfer information with sampling information for instructions executing in a processor comprising:
storing information relating to execution events;
selecting an instruction for sampling;
storing information relating to the instruction for sampling;
freezing the information relating to execution events when the information relating to the instruction for sampling is to be reported to provide frozen execution event information;
reporting the information relating to the instruction for sampling; and,
enabling access to the frozen execution event information.

2. The method of claim 1 further comprising:
freezing the execution event information provides information to enable reconstructing an execution path of events adjoining the instruction.

3. The method of claim 1 wherein:
the storing information relating to execution events and the storing information relating to the instruction occur within separate structures of a processor.

4. The method of claim 1 wherein:
the freezing the information relating to execution events disables storing of additional information relating to execution events.

5. The method of claim 1 further comprising:
enabling storing information relating to execution events occurring after execution of the instruction for sampling.

6. An apparatus for linking control transfer information with sampling information for instructions executing in a processor comprising:
means for storing information relating to execution events;
means for selecting an instruction for sampling;
means for storing information relating to the instruction;
means for freezing the information relating to execution events when the information relating to the instruction for sampling is to be reported to provide frozen execution event information;
means for reporting the information relating to the instruction; and,
means for enabling access to the frozen execution event information.

7. The apparatus of claim 6 wherein:
means for freezing the execution event information provides information to enable reconstructing an execution path of events adjoining the instruction.

8. The apparatus of claim 6 wherein:
the means for storing information relating to execution events and the means for storing information relating to the instruction are located within separate modules of a processor.

9. The apparatus of claim 6 wherein:
the freezing the information relating to execution events disables storing of additional information relating to execution events.

10. The apparatus of claim 6 further comprising:
means for enabling storing information relating to execution events occurring after execution of the instruction for sampling.

11. A processor comprising:
an instruction pipeline;
a sampling mechanism coupled to the instruction pipeline, the sampling mechanism selecting an instruction for sampling and storing information relating to the instruction for sampling;
a history queue coupled to the pipeline, the history queue storing information relating to execution events, the history queue freezing the information relating to execution events when the information relating to the instruction for sampling is to be reported to provide frozen execution event information so as to enable linking control transfer information with sampling information for instructions executing in the processor.

12. The processor of claim 11 wherein:
the sampling mechanism reports the information relating to the instruction for sampling.

13. The processor of claim 11 wherein:
the history queue enables access to the frozen execution event information.

14. The processor of claim 11 wherein:
freezing the execution event information provides information to enable reconstructing an execution path of events adjoining the instruction.

15. The processor of claim 11 wherein:
freezing the information relating to execution events disables storing of additional information relating to execution events.

16. The processor of claim 11 wherein:
the history queue stores information relating to execution events occurring after execution of the instruction for sampling.

17. A method of monitoring control transfer information for instructions executing in a processor comprising:
storing information relating to execution events;
freezing the information relating to execution events when the information relating to the instruction is to be reported to provide frozen execution event information; and,
enabling access to the frozen execution event information.

18. The method of claim 17 wherein:
the freezing occurs based upon an instruction sample being reported.
